(19) United States
(12) Patent Application Publication
(10) Pub. No.: US 2009/0056390 A1
(43) Pub. Date: Mar. 5, 2009

(54) Security system

(76) Inventor: Lil Falkensson, Goteborg (SE)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 11/991,109

(22) PCT Filed: Aug. 29, 2006
(86) PCT No.: PCT/SE2006/050301

§ 371 Date: Apr. 24, 2008

Related U.S. Application Data
(60) Provisional application No. 60/713,030, filed on Aug. 30, 2005.

(51) Int. Cl. E05B 73/00; A45C 13/18

(52) U.S. Cl. 70/14; 206/1.5

(57) ABSTRACT

The present invention relates to a security system intended to prevent theft of theft-prone items. The security system comprises a retainer means intended to be mounted against a floor and/or a wall by means of fastening means, which retainer means defines a space for a storage means provided with a handle or not provided with a handle. The retainer means comprises two mutually parallel sides connected by means of a side perpendicular to said two sides. The security system further comprises a lock means connected to a first of the two parallel sides of the retainer means by means of joint means, which lock means is provided with a hole in which a locking pin arranged on the second of the two parallel sides fits. Furthermore, the security system comprises a locking means intended to be locked on the locking pin to secure the lock means and thereby the storage means.

### FIELD OF THE INVENTION

The present invention relates to a security system intended to prevent theft of theft-prone items.

Problem definition: People's mobility has today become greater and greater - we travel by car, boat and caravan, we bring valuables with us, both private, for our leisure-time activities, and at work. The needs for bringing valuables with us to where we go increase. Today, it is not only the wallet including credit cards and money that we carry, but also the mobile, MP3 players, GPS navigators, the palmtop, the portable computer and important documents. In our leisure time, we also bring expensive and in other ways valuable equipment with us. It may be weapons for hunting, equipment for climbing, sports, sailing, etc. Who has not felt compelled to bring the computer from work or has had too much valuables in the boat or the car? One becomes tied to one's valuables, and there is a necessity of bringing them along also when just going to have a meal, taking a coffee, or is forced to put them in a safety-box in the hotel where one temporary spends the night.

In addition to this, there is also a more professional need for safer storing of equipment and tools both at the office workplace, which in many cases is found in an open-plan office, and during transportation and on business trips. In the office workplace, there are computers, mobile phones and personal valuables which one does not wish to bring along in the lunch hour or at the meeting, polices and the military have weapons and explosives, craftsmen have tools and occasionally explosives, nursing staff carry medicines and narcotics for treatment.

Solution description: The security system is a mechatronic product concept (combined mechanical and electronic) that offers different solutions for a safe storage of valuables, tools or whatever one desires in the car, the caravan, the boat, at the office, in the hotel room, in the holiday house or at home. The concept consists of different security retainers that readily secure different containers, such as, for instance, standard bags and physical standard boxes but also for specially made containers in the form of different bags and boxes. The containers may, per se, have different material and design levels as protection against burglary, water and fire. The security retainer and/or the container may also be supplemented with electronic protections such as alarm and warning systems and also communication equipment. The customer may extend the protection and the possibility of, for instance, tracing a stolen vehicle by a built-in GPS installed in the electronics box. The GPS is formed so that the security retainer acts as antenna in such a way that it prevents the possibility of some one cutting/destroying the antenna! The electronics can also be used to warn the owner that an attempted burglary being underway, and then the owner can be alarmed via, for instance, SMS or only by the fact that the security system gives up alarm noise via a siren. The concept is built on modules and the customer determines himself/herself which modules, which design and which materials are desired in the complete system based on the cost, and which burglary protection is desired.

### SUMMARY OF THE INVENTION

The problems above are solved by a security system intended to prevent theft of theft-prone items according to claim 1. The security system comprises a retainer means intended to be mounted against a floor and/or a wall by means of fastening means. The retainer means defines a space for a storage means provided with a handle or not provided with a handle. The retainer means comprises two mutually parallel sides connected by means of a side perpendicular to said two sides. Furthermore, the security system comprises a lock means connected to a first of the two parallel sides of the retainer means by means of joint means. The lock means is provided with a hole in which a locking pin arranged on the second of the two parallel sides fits. Furthermore, the security system comprises a locking means intended to be locked on the locking pin to secure the lock means and thereby the storage means.

In this connection, an additional advantage is obtained if the retainer means comprises pair-wise opposite securing lugs, which make the removal of the storage means from the retainer means more difficult.

In this connection, an additional advantage is obtained if the retainer means is divided, which facilitates the removal/placing of the storage means from/into the retainer means.

In this connection, an additional advantage is obtained if the retainer means is manufactured from metal, plastic, composite material including alloys and/or reinforcements or a mixture of metal, composite material and rubber.

In this connection, an additional advantage is obtained if the security system further comprises an electronic system built-in in a module and comprising an alarm means and/or a siren and/or a GPS transmitter/receiver and/or a mobile-phone unit for SMS transmission, as well as if the retainer means comprises a built-in antenna means for communication.

In this connection, an additional advantage is obtained if the module is built-in or cast in the retainer means.

In this connection, an additional advantage is obtained if the fastening means consist of screw joints and/or glue joints.

In this connection, an additional advantage is obtained if the retainer means further comprises additional solid or partial sides arranged perpendicularly to the previously mentioned sides of the retainer means.

In this connection, an additional advantage is obtained if each of at least two mutually parallel sides of the retainer means comprises a pair of holed projections, which projections have a rectangular or square cross section in a section perpendicular to the parallel sides, wherein a plurality of retainer means can be mounted stacked on each other.

Embodiments of the invention will now be described, reference being made to the accompanying drawings, wherein:

### BRIEF DESCRIPTION OF THE DRAWINGS

FIG. 1 shows a perspective view of a first embodiment of the security system according to the present invention; FIG. 2 shows a perspective view of the security system shown in FIG. 1, without a bag; FIG. 3 shows a perspective view of the security system shown FIGS. 1 and 2, illustrating the removal of the bag;

FIG. 4 shows a perspective view of a second embodiment of the security system according to the present invention; and

FIG. 5 shows a perspective view of a third embodiment of the security system according to the present invention.

### DETAILED DESCRIPTION OF PREFERRED EMBODIMENTS

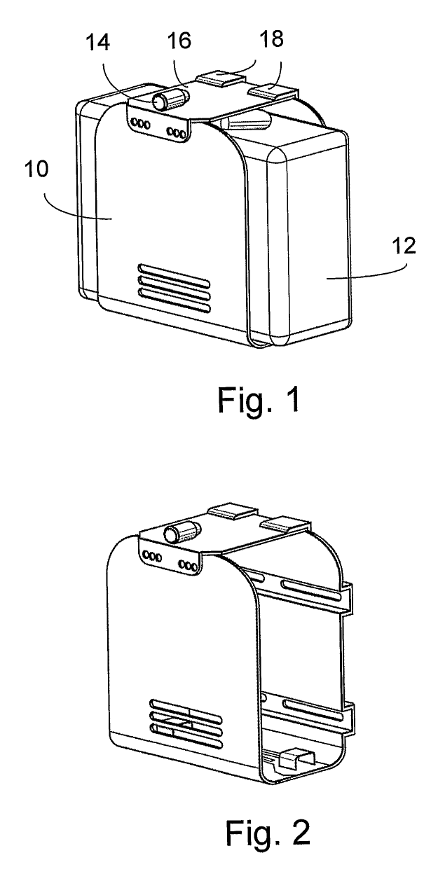

In FIG. 1, a perspective view is shown of a first embodiment of the security system according to the present invention, wherein the security retainer 10 solves the problem of securing the bag/container 12 by a lid/flap 16.

The design extends the production prospects and also extends the field of application of different containers/bags/computers and electronic devices that both are and are not constructed with handles.

The security retainer including a lid/flap has lugs to prevent the container/bag from being displaced laterally.

An electronics box (not shown) may be attached as a supplement to the security retainer 10, behind the container/bag 12 toward the surface to which the security retainer 10 is fastened. The electronics box is modularly constructed and may, for instance, comprise alarm, a siren, GPS as well as a mobile-phone unit for SMS transmission. An antenna for communication is built-in in the security retainer 10 in order to avoid destruction of the communication unit by, for instance, removing the antenna. The electronics box may also be built-in or cast into the container.

In FIG. 1, the component parts of the security system having a lid/flap as a locking device are depicted schematically. The reference designations given in FIG. 1 indicate: 10 a security retainer, 12 a bag, 14 a lock, 16 a flap and 18 hinges. The bag may be a standard bag or a specially adapted bag or container for, for instance, computers, camera equipment, weapons, explosives or other expensive equipment, which takes different types of external actions into consideration and also fire and water damage. The bag may also be a computer server. On one hand, as in this case, the lock may be a special lock, but it may also be replaced with padlocks of different security classes. When a padlock is used, the locking device is formed in accordance therewith. The bag/container is removed by unlocking the lock and turning up the lid/flap. Fastening/mounting can be effected lying or standing against a wall, floor or ceiling.

FIGS. 1 and 2. A security retainer that either may be bent into shape from metal or be cast of various composite materials. The lid/flap is articulated and can be locked by different types of special locks or usual various security-classed padlocks.

FIG. 3. The bag or the container is extracted from the security retainer by removing the lock and turning up the lid/flap. The bag may now be lifted out from the retainer thereof.

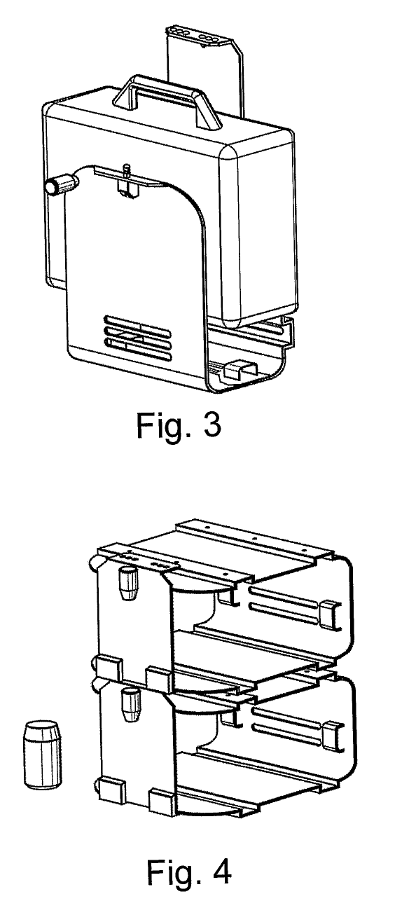

FIG. 4. In this example, the security retainer is formed to be stackable. This is, for instance, an advantage when a craftsman equips a van with tools. The security retainer can then be opened and the container/bag can be extracted from the retainer thereof without needing to restow.

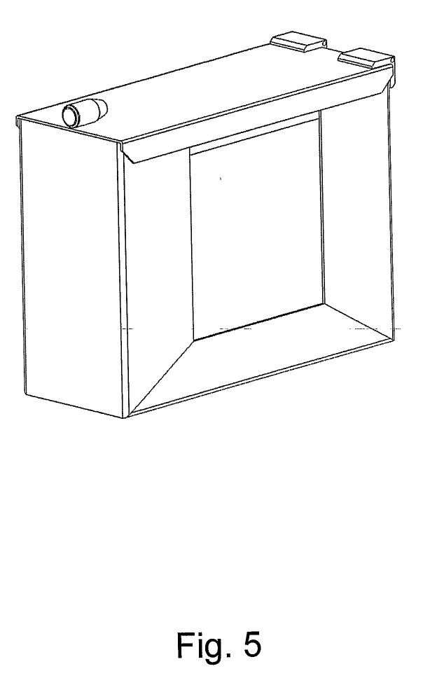

FIG. 5. Another design of a security retainer having a lid is more or less to make a box that is locked in the same way. The lid may be applied to any side.

1. A security system intended to prevent theft of theft-prone items, which security system comprises a retainer means intended to be mounted against a floor and/or a wall by means of fastening means, which retainer means defines a space for a storage means provided with a handle or not provided with a handle, which retainer means comprises two mutually parallel sides connected by means of a side perpendicular to said two sides, which security system further comprises a lock means connected to a first of the two parallel sides of the retainer means by means of joint means, which lock means is provided with a hole in which a locking pin arranged on the second of the two parallel sides fits, which security system further comprises a locking means intended to be locked on the locking pin to secure the lock means and thereby the storage means, wherein each of at least two mutually parallel sides of the retainer means comprises a pair of holed projections, which projections have a rectangular or square cross section in a section perpendicular to the parallel sides, wherein a plurality of retainer means can be mounted stacked on each other.

2. Security system according to claim 1, characterized in that the retainer means comprises pair-wise opposite securing lugs, which make the removal of the storage means from the retainer means more difficult.

3. Security system according to claim 1, characterized in that the retainer means is divided, which facilitates the removal/placing of the storage means from/into the retainer means.

4. Security system according to claim 1, characterized in that the retainer means is manufactured from metal, plastic, composite material including alloys and/or reinforcements or a mixture of metal, composite material and rubber.

5. Security system according to claim 1, characterized in that the security system further comprises an electronic system built-in in a module and comprising an alarm means and/or a siren and/or a GPS transmitter/receiver and/or a mobile-phone unit for SMS transmission, as well as in that the retainer means comprises a built-in antenna means for communication.

6. Security system according to claim 5, characterized in that the module is built-in or cast in the retainer means.

7. Security system according to claim 1, characterized in that the fastening means consist of screw joints and/or glue joints.

8. Security system according to claim 1, characterized in that the retainer means further comprises additional solid or partial sides arranged perpendicularly to the previously mentioned sides of the retainer means.
